(19) United States
(12) Patent Application Publication
(10) Pub. No.: US 2017/0320220 A1
(43) Pub. Date: Nov. 9, 2017

(54) Nasal Razor

(71) Applicant: Glenn McAndrews, Lebanon, OH (US)

(72) Inventor: Glenn McAndrews, Lebanon, OH (US)

(21) Appl. No.: 15/150,410

(22) Filed: May 9, 2016

(51) Int. Cl. B26B 21/40; B26B 21/06; B26B 21/56

(52) U.S. Cl. CPC B26B 21/4031; B26B 21/565; B26B 21/06; B26B 21/4018

(57) ABSTRACT

A miniature disposable nasal razor comprised of a handle, blades, and safety guard, used to remove hair from small confined spaces otherwise unreachable with conventional razors. An efficient inverted U-shape is applied to all blades and safety guard, otherwise maintaining the spatial relationships between blades, and blades and guard, found in conventional straight edge disposable shavers. The longitudinal axis of the shaving head is offset from the longitudinal axis of the handle providing ergonomic benefit to the user.

### CROSS-REFERENCE TO RELATED APPLICATIONS

This application claims the benefit of U.S. Provisional Application 62/159,335 filed 10 May 2015, incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention broadly relates to shaving devices and more particularly to a miniature, disposable, non-electric, razor for use in the nasal cavity to remove unwanted hair.

### BACKGROUND OF THE INVENTION

Unlike trimming the hair on one's head, the act of trimming hair from one's nostrils is not well advertised or discussed. Yet it is a common activity, especially for men. Current methods include using the fingers or tweezers to forcefully pull the hair out, using an electrically (typically a battery) operated rotary trimmer, or using a scissors. Of these, the current art is dominated by battery-operated trimmers because they are moderately successful at painlessly accomplishing the task of removing nose hair. These devices however have limitations: they lack precision, they are noisy, and they require cleaning.

The prior art is replete with inventions relating to hair trimmers and shavers including those designed to access small confined spaces like the nasal cavity or ear. Judging from the lack of commercially available disposable nasal razors, it appears that none of prior art non-electric inventions have been adopted, and so there still remains an unfulfilled need in the marketplace for an option to the battery-operated type trimmer.

Heinrich's early miniature razor, U.S. Pat. No. 2,139,680 is admirably simple, but producing a tiny cutting blade with a contoured cutting edge (the edge hereafter called a “cutter”) is difficult. Andrews's U.S. Pat. No. 6,505,403 correctly teaches the advantage of using a U-shaped blade made from thin, traditional, straight-edged razor steel. This device suffers however in the relationship between safety guard and cutter.

It is therefore an object of the present invention to provide a nasal safety razor that is non-electric, disposable, operated like current day disposable razors for the face, can be multi-bladed, economical, uses an efficient U-shaped cutter, and employs a safety guard similar to those used in the currently available disposable razor.

### SUMMARY OF THE INVENTION

Briefly described, a nasal razor is disclosed for use by personnel in those situations where it is necessary to remove hair from confined spaces (like the nose); whereas the possibility of performing this feat with a conventional razor, is prevented due to size and shape.

The present invention introduces a lightweight, hand manipulated, non-electric razor or shaver that like most current day disposable razors, is comprised of a few simple parts. Similarly, each of the parts can be mass-produced, and final assembly requires only one or two steps, each easily automated.

The present invention provides a slim handle to be held by the user's fingers. Integrally made with the handle, a shaving head section provides mounting features for one or more inverted U-shaped razor blades. The blades are interposed between a safety guard and an optional tip-cap. Both safety guard and upper cap are integrally made with the handle.

The radius of curvature defining the inverted “U” for each blade is different allowing the larger blade to be positioned over the smaller blade, in a “nested” arrangement. Each blade is equipped with a single cutter. Each blade contains two apertures located at the blade's extremities. Preferably, the apertures are square in shape.

Depending on the number of blades, the shaving head contains two, four, or six mounting slots that receive the end portions of one, two, or three blades, respectively. Locking tabs are located in the bottom of each slot; the tab geometry designed to agreeably penetrate and engage the blades' apertures. Once engaged in this fashion, the blade is permanently secured in place. Once inserted, back and forth motion or “rocking” of the blade is prevented because the width of each slot is closely matched to the width of the blade. Conveniently, the spring-like tendency for the blades' U-shape to “open” maintains engagement of aperture and tab.

Finally, the longitudinal axis of the shaving head is deliberately offset from the longitudinal axis of the handle in a manner that accounts for, and facilitates how the razor is held and used.

### BRIEF DESCRIPTION OF THE DRAWINGS

The advantages and features of the present invention will become better understood with reference to the more detailed description and drawings wherein like numerals are employed to designate like parts throughout the drawings and:

FIG. 1 is a side view of the present invention;

FIG. 2 is a fragmentary perspective view of the :FIG. I invention shaving head;

FIG. 3 is a sectional view of the inserted blade in a slot;

FIG. 4 is a plan view of a blade;

FIG. 7 is a rear view of the present invention looking down the longitudinal axis;

FIG. 6 is a front view of the present invention looking up the longitudinal axis;

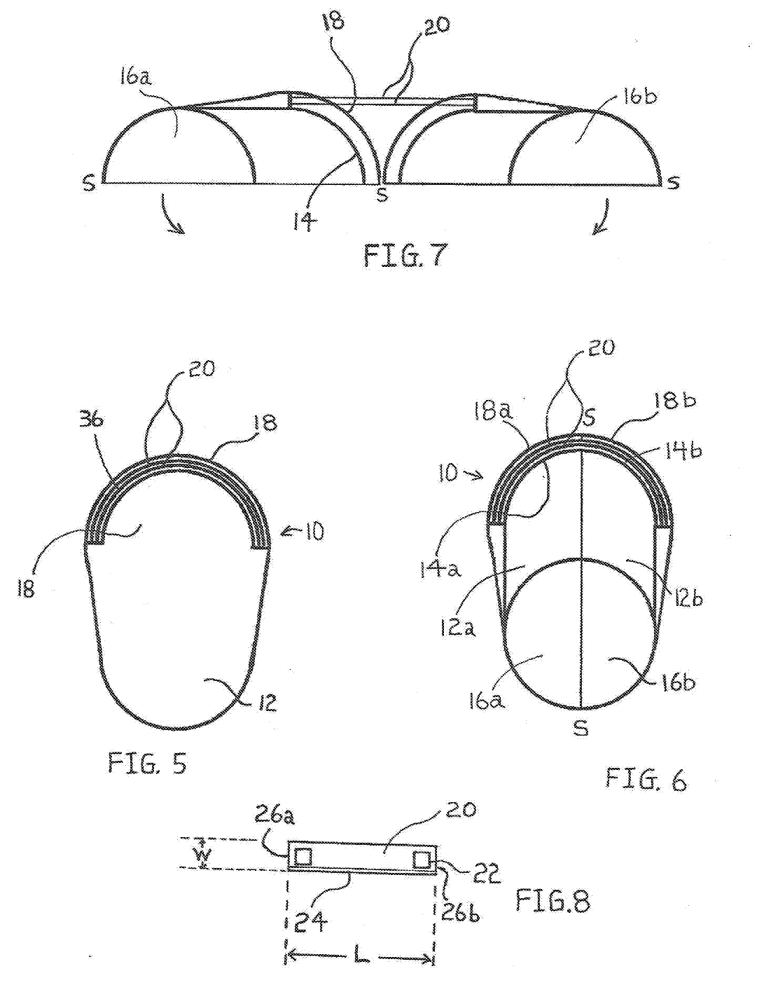

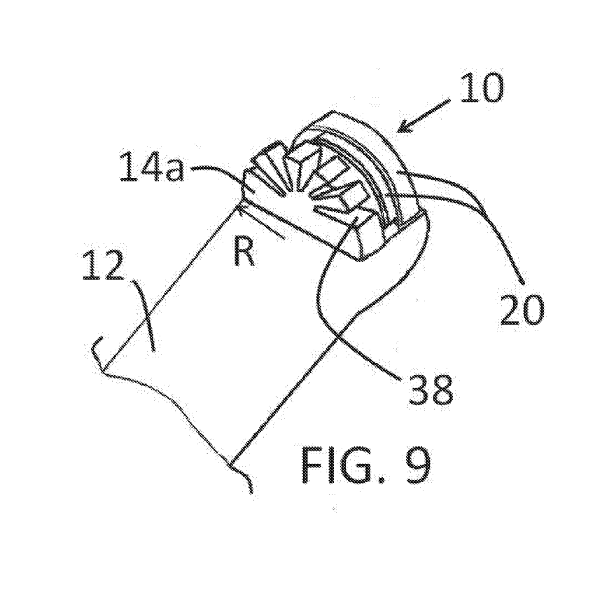

FIG. 7 is a front view of the FIG. 6 invention vertically split in half along surface “S”;

FIG. 8 is an additional plan view of a blade;

FIG. 9 is a fragmentary perspective view of alternate embodiment of the shaving head.

### DETAILED DESCRIPTION OF THE INVENTION

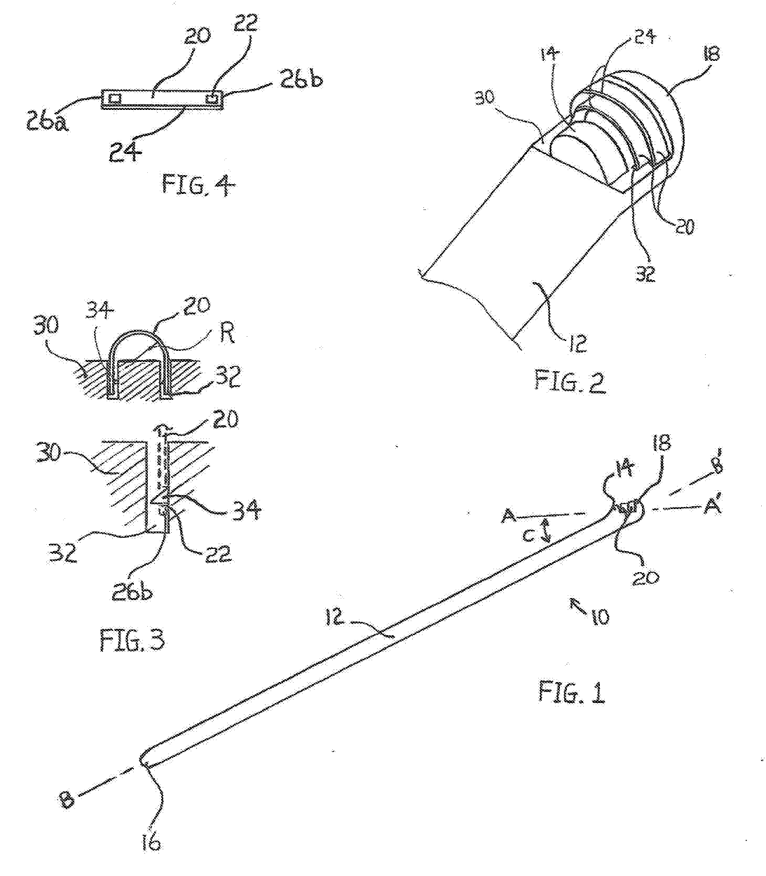

Referring now to FIG. 1 and FIG. 2, there is shown nasal razor 10 comprised of handle 12, bottom 16, blades 20, safety guard 14, and optional tip-cap 18. The invention's “shaving head” is defined by the combination of guard 14, blades 20, deck 30, slots 32, and tip-cap 18. The longitudinal axis of the “shaving head” is denoted by the line marked A-A′. Similarly, the longitudinal axis of handle 12 is denoted by the line B-B′. Lines A-A′ and B-B′ are offset by some angle denoted by the letter “C”. Preferably angle “C” is nominally 30 degrees, but acceptable results are obtained in a range of 15 to 50 degrees.

FIG. 2 and FIG. 3 shows deck 30, a flat planar surface that accommodates guard 14, slots 32, and blades 20. In this embodiment, two blades 20 are “nested”; larger blade 20 positioned behind but also on top of smaller blade 20. The semi-circular shape of each blade 20 is defined by a radius of curvature, (the straight line “R” in FIG. 3) the radius being dictated by the lateral spacing of opposing slots 32 in deck 30. Slots 32 when spaced further apart results in a larger radius of curvature of blade 20.

Other slot 32 and deck 30 configurations are envisioned. For example, rather than slot 32 being perpendicular to deck 30 as shown in FIG. 3, there are advantages to slot 32 being located parallel to and slightly below deck 30 (this “side-entry” configuration not shown).

The overlapping blade arrangement of FIG. 2 is not unlike the conventional multi-bladed disposable straight razor well known in today's marketplace. One can describe it a “lift-and-cut” technology.

Referring again to FIG. 2, in this embodiment the radius of curvature of guard 14 is made slighter smaller than that of smallest blade 20. This results in safety guard 14 that like the conventional straight-edge disposable razor, is uniformly lower than cutter 24 anywhere around its semi-circular shape (shown also in FIG. 6 later). FIG. 2 additionally teaches that tip-cap 18 does not substantially extend vertically upward past the apex of tallest blade 20. Doing so tends to displace razor 10 away from the cutting surface (not shown) and therefore reduces cutting efficiency. Finally, FIG. 2 teaches that guard 14 is positioned in front of smallest blade 20 and displaced (longitudinal separation) from cutter 24 generally by an amount of 0.25 to 1.5 mm.

Alternatively, FIG. 9 depicts an embodiment of invention 10 eliminating the tip cap. This embodiment also shows guard 14a having a radius of curvature, “R”, slightly larger than any of the blades 20. Without any further modification, “taller” guard 14a would prevent blades 20 from contacting the intended cutting surface. It is necessary therefore to introduce one or more channels 38 to guard 14a in order to allow hair to come into contact with blades 20.

FIG. 4 depicts blade 20, further containing apertures 22, cutter 24, and end portions 26a and 26b. Embodiment FIG. 8 shows blade 20, defining width “W” and length “L”. Generally, width “W” ranges between 1 and 4 millimeters and length “L” ranges between 5 and 15 mm.

FIG. 3 elucidates the details of slot 32, after having cooperatively received blade 20. Contained in slot 32, tab 34 is dimensioned to agreeably penetrate apertures 22 after end portions 26a and 26b have downwardly passed thereupon.

FIG. 5 introduces semi-circular shaped annulus 36 contained in optional tip-cap 18. Should tip-cap 18 be employed, annulus 36 allows passage of cut hair during shaving or water during flushing and cleaning. In this embodiment, handle 12 is shown as a single-piece construction.

FIG. 6 shows invention 10 formed together from mirror-imaged right and left halves, wherein halved components are denoted with like numerals and “a” and “b” suffixes. Line S-S is meant to identify the surface where the halves mate together (mating features not shown). Splitting invention 10 along surface S-S in this manner is done to facilitate the assembly of blades 20 into invention 10. As shown in FIG. 7, with the two halves rotated apart, blades 20 can be inserted into slots 32 (refer to FIG. 2) while they are straight. Once inserted, the two halves can be rotated and joined together using any number of joining methods, like glue, bands, snaps, etc.(these methods not shown). This assembly technique is only one of several methods that can be used to bend the otherwise straight blades into their final inverted U shape. Another technique is forming over a mandrel (not shown).

With reference to FIG. 1-FIG. 9, material selection and manufacture of blades 20, handle 12, guard 14, tip-cap 18 is purposely identical with disposable face razors currently in use. This strategy leverages then the existing industrial infrastructure. Except for the blades 20 made from stainless steel, the remaining components are made of plastics.

Referring now to FIG. 1 and FIG. 2, the operation of nasal razor 10 will be disclosed. Unlike most shaving devices, the razor does not require shaving cream, soap, or other lubricants. Otherwise, use of the razor 10 when removing nose hair, is not unlike using a conventional face-shaving disposable razor. The razor is manipulated in the fingers in order to position it so that cutter 24 is pointed toward the user's face. The size and shape of the shaving head, comprised of guard 14, deck 30, blades 20, and tip-cap 18, allows it to be inserted inside the nasal cavity. The razor is scrapped downward against those surfaces where hair is not desired. Occasionally, it may be necessary to rinse the shaving head with water.

Advantages of the present invention include, without limitation, the following: 1. the razor can be made from one injection mold and uses only a small amount of material. 2. The blades are initially straight and therefore producible, being bent upon insertion and assembly. 3. Due to the economy of construction the unit cost is very small rendering a truly disposable razor. 4. The safety guard uses the same technology as the conventional straight edge disposable razor. 5. The blade's inverted “U” shape is the most optimum cutting configuration for areas like a nasal cavity. 6. The unit does not make noise, 7. The unit does not require batteries.

In broad embodiment, the present invention is a nasal razor for eliminating hair from small confined spaces, unreachable using conventional shavers, comprised of a handle, an inverted U-shaped safety guard, one or more inverted U-shaped blades, each with a single cutter, and an optional tip-cap.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Having thus described my invention I claim:

1. A manually operated, non-electric, disposable, razor for removing unwanted hair from the nasal cavity, nostrils, nose, or ear canal, comprising:
a handle;
a shaving head containing:
one or more inverted U-shaped blades,
an inverted U-shaped safety guard;
whereby said safety guard is positioned in front of and in close proximity to said blades.

2. The invention as in Maim 1 where the safety guard contains channels.
